(19) United States
(12) Patent Application Publication
(10) Pub. No.: US 2021/0380353 A1
(43) Pub. Date: Dec. 9, 2021

(54) APPARATUS AND METHOD FOR DESTACKING OBJECTS

(71) Applicant: Dishcraft Robotics, Inc., San Carlos, CA (US)

(72) Inventors: Kevin Yuan Ma, Milpitas, CA (US); Paul M. Birkmeyer, San Carlos, CA (US)

(21) Appl. No.: 17/343,688

(22) Filed: Jun. 9, 2021

Related U.S. Application Data
(60) Provisional application No. 63/036,694, filed on Jun. 9, 2020.

(51) Int. Cl. B65G 59/04; B65G 59/10; B25J 15/06; B25J 15/00

(52) U.S. Cl. CPC B65G 59/04; B65G 59/106; B25J 15/0066; B25J 15/0608; B25J 15/0019; B25J 15/0616

(57) ABSTRACT

Apparatus and methods for destacking objects are disclosed. An apparatus includes a robotic arm, and an end effector connected to the robotic arm. The end effector including a grasping element for grasping an object and means for clearing a surface of the object before the grasping element grasps the object at the surface. A method for mechanically destacking dishware involves moving an end effector near to a top dish in a stack of dishware, clearing an area on a surface of the top dish by sweeping a scraper bar of a scraper mechanism over the surface of the top dish in a first direction, wherein the scraper bar is mechanically connected to the end effector, and grasping, with a grasping element of the end effector, the top dish at the area on the surface of the top dish that has been cleared by the scraper.

### CROSS-REFERENCE TO RELATED APPLICATION

This application is entitled to the benefit of provisional U.S. Patent Application Ser. No. 63/036,694, filed Jun. 9, 2020, which is incorporated by reference herein.

### BACKGROUND

For storage density and in order to reduce human operator actions, dirty dishes may be brought into a robotic dish washing system in stacks on dish carts. Cleaning operations, whether scrubbing or otherwise, may be performed individually on the dirty dishes rather than on the stacks of dishes. The dirty dishes may need to be parsed from the stack (also referred to as “destacked”) and transferred from the stack into another part of the robotic dish washing system, such as to a conveyance system for scrubbing. However, due to the nature of dirty dishes, destacking dirty dishes is not a trivial task.

### SUMMARY

Apparatus and methods for destacking objects are disclosed. In an embodiment, an apparatus includes a robotic arm, and an end effector connected to the robotic arm. The end effector including a grasping element for grasping an object and means for clearing a surface of the object before the grasping element grasps the object at the surface.

In an embodiment, the means for clearing includes a rigid scraper bar.

In an embodiment, the means for clearing includes a spring-loaded scraper mechanism. In an embodiment, the spring-loaded scraper mechanism includes a rigid scraper bar. In an embodiment, the spring-loaded scraper mechanism includes a torsion spring attached to a pivot to provide increased tension as the scraper bar rotates about the pivot to clear the surface of the object. In an embodiment, the spring-loaded scraper mechanism is configured to sweep across the surface of the object in response to a force applied to the spring-loaded scraper mechanism by contact between the rigid scraper bar and the surface of the object. In an embodiment, the spring-loaded scraper mechanism includes a flap connected to clear a surface of the grasping element. In an embodiment, the flap is connected to the spring-loaded scraper mechanism to clear the surface of the grasping element after the grasping element has released the object from its grasp.

In an embodiment, the means for clearing includes a locking mechanism that locks the means for clearing in a fixed position while the grasping element is grasping the object.

In an embodiment, the grasping element includes a linearly actuated retractable magnet attached at a distal end of the end effector.

In an embodiment, the means for clearing includes a locking mechanism that locks the means for clearing in a fixed position while the linearly actuated retractable magnet is in an extended position.

In an embodiment, the locking mechanism includes a locking element integrated into the means for clearing such that the locking element is held in position by magnetic attraction between the linearly actuated retractable magnet and the locking element when the linearly actuated retractable magnet is in the extended position.

In an embodiment, a linear direction of travel of the linearly actuated retractable magnet and the area that is cleared by the means for clearing are linearly aligned with each other.

In an embodiment, the grasping element includes a channel opening through which a vacuum can be provided.

A method for mechanically destacking dishware is also disclosed. The method involves moving an end effector near to a top dish in a stack of dishware, clearing an area on a surface of the top dish by sweeping a scraper bar of a scraper mechanism over the surface of the top dish in a first direction, wherein the scraper bar is mechanically connected to the end effector, and grasping, with a grasping element of the end effector, the top dish at the area on the surface of the top dish that has been cleared by the scraper.

In an embodiment, the method involves releasing the dish that is grasped by the grasping element and, after the dish is released, clearing a surface of the grasping element by sweeping the scraper bar of the scraper mechanism in a second direction that is opposite the first direction. In an embodiment, the scraper bar is swept in the second direction by a torsion spring.

In an embodiment, the scraper bar is swept over the surface of the top dish by pressing the scraper mechanism against the surface of the top dish. In an embodiment, the method involves releasing the dish that is grasped by the grasping element and, after the dish is released, clearing a surface of the grasping element by sweeping the scraper mechanism in a second direction that is opposite the first direction. In an embodiment, the method involves locking the scraper mechanism in place while the dish is grasped by the grasping element.

An apparatus for destacking stacked dishware is also disclosed. The apparatus includes a robotic arm, and an end effector connected to the robotic arm, the end effector including a magnetic grasping element for grasping a top dish from a stack of dishware, and a spring-loaded scraper mechanism configured to clear a surface of the top dish before the magnetic grasping element grasps the top dish at the surface.

In an embodiment, the spring-loaded scraper mechanism includes a rigid scraper element. In an embodiment, the spring-loaded scraper mechanism includes a flap connected to a side frame member of the spring-loaded scraper mechanism to clear the surface of the grasping element after the grasping element has released the dish from its grasp. In an embodiment, the spring-loaded scraper mechanism includes a locking mechanism configured to lock the scraper bar in a fixed position after the scraper bar has cleared the surface of dish.

In an embodiment, the magnetic grasping element includes a linearly actuated retractable magnet and wherein the locking mechanism comprises a locking element integrated into a side frame member of the spring-loaded scraper mechanism such that the locking element is held in position by magnetic attraction between the linearly actuated retractable magnet and the locking element when the linearly actuated retractable magnet is in an extended position.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a destack system.

FIG. 2 is a perspective view of an embodiment of the end effector shown in FIG. 1.

FIG. 3 is a side cutaway view of the end effector shown in FIG. 2.

FIG. 4 depicts another side cutaway view of the end effector in which the magnet is in a retracted position.

FIG. 5 depicts an embodiment of the end effector that includes a passive, undriven mechanism to clear debris from the surface of an article of dishware that is to be magnetically grasped.

FIG. 6 is a more detailed view of the mechanism that supports movement of the scraper.

FIG. 7 depicts the end effector and the scraper with the scraper bar in a position that exists after the scraper bar has been forced to sweep entirely across the surface of an article of dishware.

FIGS. 8A-8D illustrate how the scraper bar of the scraper clears an area on a surface of a dish by sweeping the scraper bar over the top surface of the dish.

FIG. 9 depicts the end effector in a grasping position.

FIG. 10 depicts when the end effector has retracted the magnet to release an article of dishware.

FIG. 11 depicts the scraper bar after the torsion spring has pivoted the scraper bar back across the end effector to its undeflected position.

FIG. 12 is a process flow diagram of a method for mechanically destacking dishware.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

There are a number of challenges with manipulating dishes individually from a stack, including, for example: 1) stack density provides less room and fewer features to grasp; 2) the edge of a dish could be touching the edge of the dish below it; 3) edge-grasping approaches becomes difficult; 4) dishes, even of the same type from the same manufacturer, can vary in dimension; 5) because they are constructed from brittle, hard materials (e.g., ceramics, etc.), it is challenging to manipulate them quickly and reliably without breakage; 6) dishes are often covered with unknown amounts, and types, of foods; 7) foods bond to dishes, and can effectively bond dishes to each other; 8) dishes in a stack may be poorly constrained, allowing dishes to be presented tilted or shifted relative to a target location, which is particularly true of bowls; 9) non-dish, non-food objects, are commonly in the stack despite quality controls and training, including napkins, utensils, wrappers, silverware, etc., and such non-food objects can interfere with grasping, and can also clog or damage components in a dish cleaning system if brought into the dish cleaning system.

The destack system described herein may provide some or all of the following benefits: 1) high speed operation because physical motions are reduced, and movement between steps is fast, the system is capable of achieving high accelerations, which relies on reducing the mass of the manipulator, and reducing the distance of the mass from the fixed/ground connections of the manipulator; 2) robust to variable dish locations; 3) robust to inaccurate information about the dish type; 4) robust to inaccurate location/orientation of the dish; 5) rejects processing unfamiliar dishes, or known objects which might break the system (silverware, etc.); 6) compact in size (system footprint is valuable, and therefore the physical size of manipulators can be seen as a cost); 7) robust to foods present on the surface of the dish, both above and below the dish; and 8) robust to adherence between dishes.

In order to achieve at least some of the above-identified benefits, a destack system and method of destacking dishware is disclosed. In an embodiment, a destacking system includes a robotic arm and an end effector connected to the robotic arm and the end effector includes a grasping element (e.g., a magnetic grasping element) for grasping an article of dishware and a scraper mechanism configured to clear a surface of the article of dishware before the grasping element grasps the article of dishware at the surface. In an embodiment, the scraper mechanism includes a rigid scraper bar and a spring-loaded scraper mechanism. In an embodiment, the spring-loaded scraper mechanism includes a torsion spring attached to a pivot to provide increased tension as the scraper bar rotates about the pivot to clear the surface of the article of dishware. Additionally, the spring-loaded scraper mechanism may be configured to sweep across the surface of the article of dishware in response to a force applied to the spring-loaded scraper mechanism by contact between the rigid scraper bar and the surface of the article of dishware. As used herein, the terms article of dishware, dishware, ware, and dish may be used interchangeably herein to refer to articles of dishware such as plates, bowls, cups, pots, pans, reusable containers, lids and other articles that are used to prepare, serve, hold, carry, and/or transport food or beverages for human consumption.

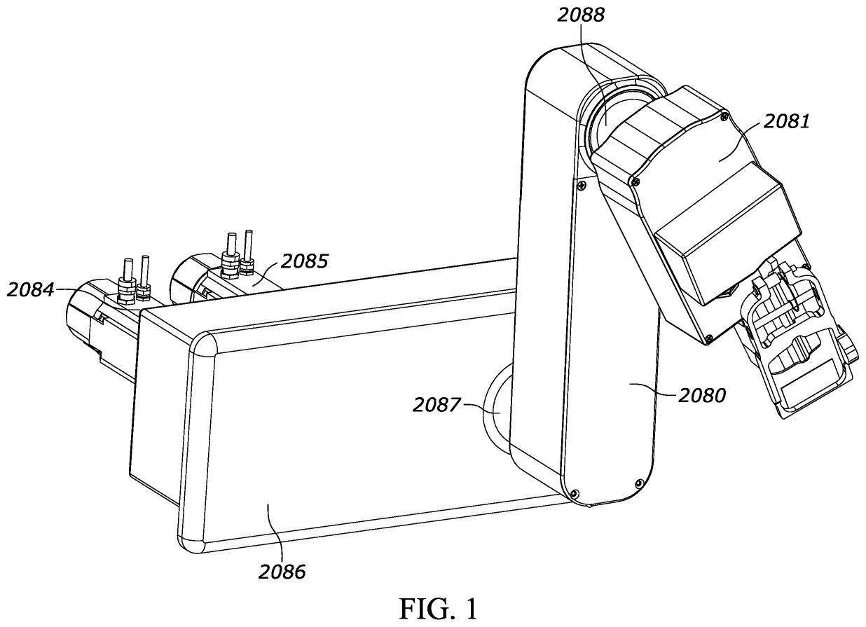

Referring to FIG. 1, the destack system may include a robotic arm 2080 that is mounted to a fixed structure, such as a housing containing some or all of the components described herein and is rotatable relative to a fixed point about a first axis of rotation. An end effector 2081 may be mounted to the arm 2080 offset from the first axis of rotation. The end effector 2081 may be rotatable relative to the arm 2080 about a second axis of rotation that is offset from the first axis of rotation. The second axis of rotation may be substantially (e.g., within 5 degrees) parallel to the first axis of rotation.

The arm 2080 may be rotated by an actuator 2084 and the end effector 2081 may remain static or may be rotated in correspondence with rotation of the arm 2080, e.g., a gear or pulley link may constrain the end effector 2081 to rotate in a predefined relationship to rotation of the arm 2080. Alternatively, a second actuator 2085 may be coupled to the end effector 2081 and rotate the end effector 2081 independently. The actuator 2084 and possibly the actuator 2085 may be coupled to a controller and controlled thereby. Sensors for detecting the orientation of the arm 2080 and end effector 2081 may be used and provide feedback to a controller or the actuators 2084, 2085 may include absolute encoders such that the angular positions are known. In an embodiment, each actuator 2084, 2085 includes a motor and the actuator 2084, and possibly the actuator 2085, may include one or more other features, such as a power-off electromagnetic brake, planetary gearbox coupling the motor to an output shaft, and a mounting plate.

In the illustrated embodiment, the actuators 2084, 2085 are motors coupled to the arm 2080 and to the end effector 2081 by a transmission 2086. In particular, the transmission 2086 may drive a shaft 2087 coupling the arm 2080 to the transmission 2086. Likewise, a shaft 2088 coupling the end effector 2081 to the arm 2080 may be driven by the transmission 2086.

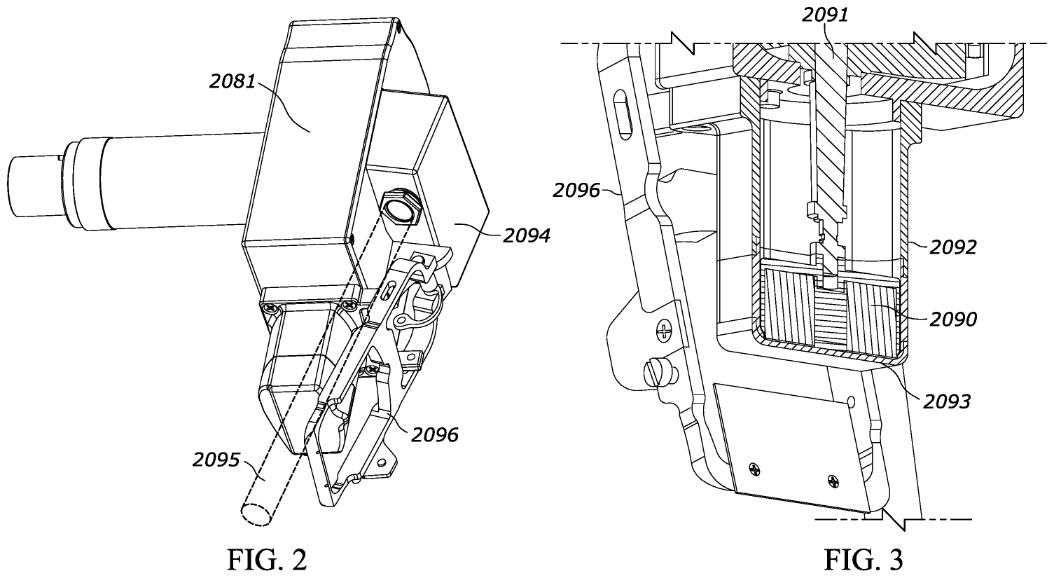

FIG. 2 is a perspective view of an embodiment of the end effector 2081 shown in FIG. 1 and FIG. 3 is a side cutaway view of the end effector shown in FIG. 2. Referring to FIG. 3, the end effector 2081 may incorporate a magnet 2090 coupled to a linear actuator 2091 (e.g., solenoid or a rack and pinion driven by an electric motor) coupled to a controller (not shown) that invokes extension and retraction of the magnet 2090 in order to magnetically grasp and release wares that include embedded ferromagnetic material. Wares processed according to the systems and methods disclosed herein may be as described in U.S. application Ser. No. 15/665,260 filed Jul. 31, 2017 and entitled DISH MANIPULATION SYSTEMS AND METHOD, which is hereby incorporated herein by reference in its entirety.

With reference to FIG. 3, the magnet 2090 may be located within a sheath 2092, which may be generally cylindrical. An end of the sheath 2092 may be placed on a ware and the magnet 2090 extended toward the distal (bottom) end of the sheath 2902 in order to magnetically attract and secure the ware. To release the ware, the magnet 2090 is retracted within the sheath, thereby decreasing magnetic attraction until the ware is released. The distal end of the sheath 2092 may be covered by a removable cap 2093 in order to prevent contamination of the magnet 2090 and the actuator 2091 and to permit replacement and inspection of the magnet 2090. The cap 2093 may be made of or include a cover made of a compliant material (e.g., rubber, silicone, etc.) in order to reduce scratching and breakage of dishes.

One or more sensors may be incorporated into the end effector 2081 in order to detect wares secured to the end effector 2081 or to be picked up by the end effector 2081. For example, with reference to FIG. 2, a sensor 2094 may be embodied as a distance sensor that detects a distance to an item positioned below the end effector. In particular, note that angle of the field of view 2095 of the sensor 2094 may be angled slightly (e.g., 5-20 degrees) relative to the actuation direction of the linear actuator 2091 and positioned such that an object intersected by the actuation direction and offset along the actuation direction by some tolerance (e.g., 1-5 cm) from the end cap 2093 will be in the field of view 2095 and detectable by the sensor 2094.

The sensor 2094 may be positioned such that it is not occluded by a scraper 2096 at any position of the scraper. The function of the sensor 2094 may be to measure the distance from the end effector 2081 to the dish surface. This distance can be used to confirm successful grasping of a dish (e.g., distance is below a threshold indicating grasping), detect dropping of a dish (e.g., distance suddenly increases during movement of end effector 2081), and aid in positioning the arm 2080 relative to the dish stack during a grasp event. The distance sensor may be embodied, for example, as an ultrasonic sensor, laser sensor, infrared sensor, or the like. When the articles of dishware include embedded ferromagnetic material as described in U.S. application Ser. No. 15/665,260 filed Jul. 31, 2017 and entitled DISH MANIPULATION SYSTEMS AND METHOD, a Hall-effect sensor may be used for detection as well. Other sensors such as a strain gauge or other force sensor may be used to detect incidence of the end effector on wares or other objects. Images from a nearby camera (not shown) may also be used to detect and classify objects within an area accessible by the end effector 2081. Various other end effectors may be used other than a magnetic end effector, such as a claw, pincers, vacuum or suction gripper, or the like. For example, in an embodiment, the end effector includes a channel through which a vacuum is provided to grab an article if dishware through vacuum.

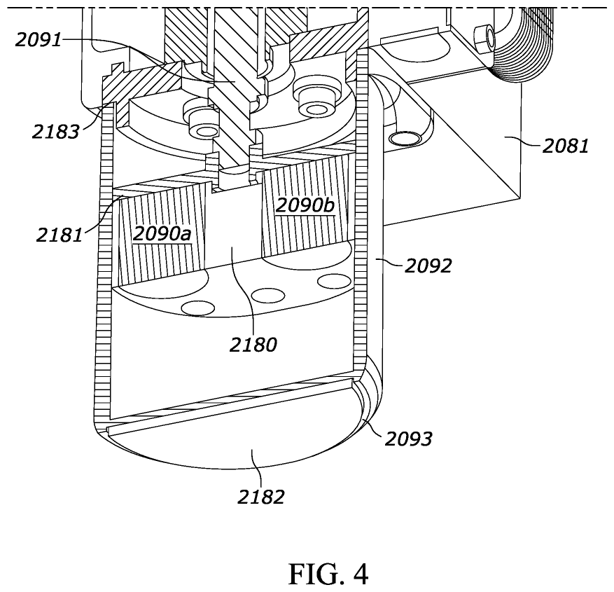

FIG. 4 depicts another side cutaway view of the end effector in which the magnet is in a retracted position. With reference to FIG. 4, in some embodiments, the magnet 2090 may be embodied as two magnets 2090a, 2090b mounted within a spacer 2180 that maintains the magnets 2090a, 2090b separate from one another and defines an outer surface conforming to the shape of the sheath 2092 to facilitate sliding within the sheath 2092. The magnets 2090a, 2090b may be actuated between a completely extended position against the end cap 2093 for gripping or retracted away from the end cap 2093 for releasing a gripped ware. The magnets 2090a, 2090b may include a first exposed face that faces toward the end cap 2093 and an opposite face that interfaces and possibly contacts an end plate 2181. In particular, a north end of one magnet 2090a faces the end plate 2181 and a south end of the other magnet 2090b faces the end plate 2181. The end plate 2181 may be a ferrous material, such as low carbon steel or iron. In contrast, the spacer 2180 may be a non-ferrous material such as plastic chosen to provide low friction relative to the sheath 2092. The magnet 2090 shown in FIG. 3 may be embodied as a combination of magnets 2090a, 2090b and spacer 2180 as shown in FIG. 4 and described above. In other embodiments, a single magnet 2090 is used either alone or embedded into a plastic spacer.

FIG. 4 illustrates an alternative to the sheath 2092 and end cap 2093 of FIG. 3. In particular, the end cap 2093 may be formed integrally or monolithically with the sheath 2092 in the embodiment of FIG. 4 and therefore be made of the same rigid plastic or metal of which the sheath 2092 is formed. Accordingly, in the embodiment of FIG. 4, a pad 2182 may be secured over the end cap 2093 to reduce breakage or scratching of wares. The pad 2182 may be formed of a cushioning material, such as rubber and may also be a high friction material that may be further textured to enhance gripping. The pad 2182 may reduce slipping of wares relative to the end cap 2093 during acceleration and deceleration during transport. A seal 2183 may be positioned between a flange on the sheath 2092 and the housing of the end effector 2081 to prevent ingress of contaminants.

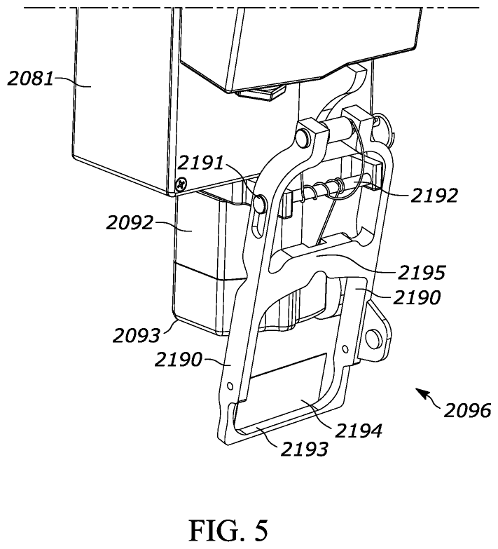

A variety of debris, including food scraps, garbage, and silverware, will typically be present on the surface of dirty dishware that is presented to a robotic dishwashing system for cleaning. It may be desirable to clear the debris so that the magnetic grabber of the robotic system can reliably grasp and manipulate the dishware. As shown in FIGS. 2 and 3, a scraper 2096 is mounted to the end effector and is configured to clear debris from wares that may interfere with gripping by the magnet 2090. An example implementation of the scraper 2096 is described in further detail below with reference to FIGS. 5-11.

FIG. 5 depicts an embodiment of the end effector that includes a passive, undriven mechanism that relies on the relative motion between the dishware and a grasping end effector, such as the magnetic end effector 2081 described herein, to clear debris from the surface of an article of dishware that is to be magnetically grasped. In the embodiment of FIG. 5, the scraper 2096 includes side frame members 2190, a scraper bar 2193, a cross bar 2195, a pivot 2191, and a torsion spring 2192. In an embodiment, the scraper 2096 is attached to the end effector 2081 and ultimately to the robotic arm 2080 (FIG. 1) and in operation, as the end effector 2081 pushes downward on the surface of an article of dishware, the scraper 2096 is forced laterally across the surface of the article of dishware, pushing aside debris as the scraper bar 2193 sweeps across the surface of the article of dishware. By pushing aside debris, the scraper clears the surface of the dishware and enables the magnetic grasping end effector to make better contact with the magnetic dishware and thus, more reliably grasp the dishware for further manipulation. The scraping of debris on the surface of dishware is particularly helpful when the debris is not compressible and would block the magnetic end effector from adequately contacting the surface of the dishware. Because magnetic force decreases rapidly as a point moves away from the magnet, the strength and consistency of the grasp is sensitive to the distance between the magnet and the grasped object. The magnetic end effector 2081 may need to consistently achieve close contact with the dishware surface to reliably grasp and manipulate dishware at the speeds and forces desired for a high throughput robotic dishwashing system.

In the embodiments described herein, the dish scraper 2096 is attached to the outside of the housing of the end effector 2081. The scraper includes the torsionally-sprung rigid scraper bar 2193 pivoting about a fixed pivot 2191 on the end effector housing. As the end effector approaches the surface of a dish to grasp the dish, the scraper bar contacts the surface first. Because the scraper bar is sprung outward, the scraper bar maintains contact with the surface of the dish as the end effector continues to approach and contact the dish. The scraper bar rotates as the force vector on the contact point applies a torque about the fixed pivot. As the end effector continues to approach the dish surface, the scraper bar slides and scrapes across the surface of the dish directly beneath where the end effector's rubber pad would make contact, clearing the surface of debris.

Referring still to FIG. 5, the scraper 2096 may include a frame including one or two side frame members 2190 that are mounted to the end effector 2081 by the pivot 2191, such as a pin passing through the frame members 2190 and through a flange affixed to the end effector, such as to the sheath 2092 in the illustrated embodiment. The frame is biased about the pivot 2191, such as by means of a torsion spring 2192 encircling the pin and having end portions contacting the frame and the end effector 2081. The torsion spring 2192 biases the distal end of the frame extending below the end cap 2093 in the illustrated view away from the end cap 2093 (counter clockwise in the illustrated view).

The frame may further include the scraper bar 2193 at the distal end, such as extending between the two frame members 2190. The scraper bar 2193 may be straight to facilitate even scraping across dishware cleared thereby. In the illustrated embodiment, a flap 2194 is secured to the scraper bar 2193 and is made of a flexible material that is able to bend when contacted by the end cap 2093 or sheath 2092.

In an embodiment, to keep the combined envelope of the end effector and scraper mechanism small, the scraper bar 2193 is shortened (along a dimension perpendicular to its long dimension extending between frame members 2190) to just clear the end effector housing's envelope (e.g., with a clearance of from 1 to 10 mm). The short scraper bar enables loose debris to roll over the bar 2193 and redeposit on the scraped surface. To prevent this debris from redepositing, a flexible bar extension (flap 2194), made of elastic polymer sheet, may be added on top of the bar and extend upwardly therefrom, e.g., away from the surface being scraped when the scraper bar 2193 is first contacted to the surface. For example, extending toward the pivot 2191 or toward the end cap 2093.

In the illustrated embodiment, an intermediate cross bar 2195 extends between the frame members 2190 between the pivot 2191 and the scraper bar 2193 to further stiffen the frame. In the illustrated embodiment, the cross bar 2195, scraper bar 2193, and frame members 2190 define an opening that is sized and positioned to permit the sheath 2092 to pass therethrough without interference when deflected across the sheath 2092 as described below.

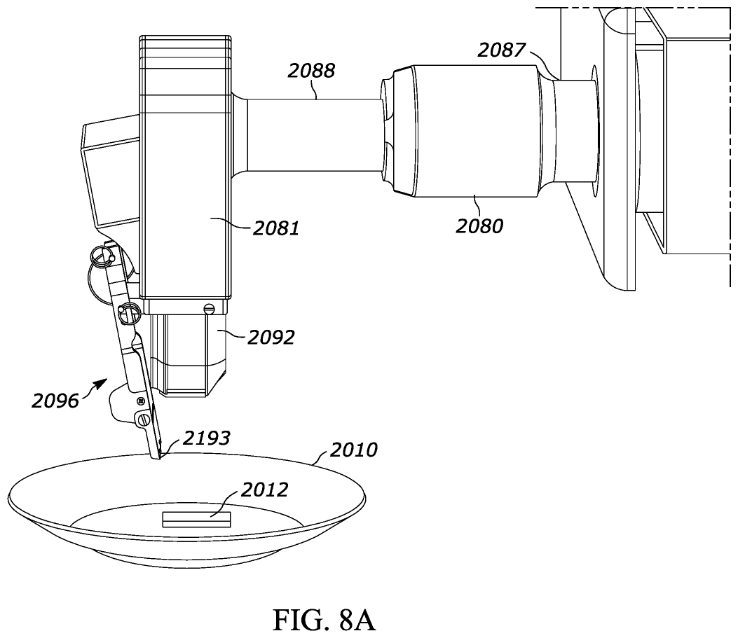

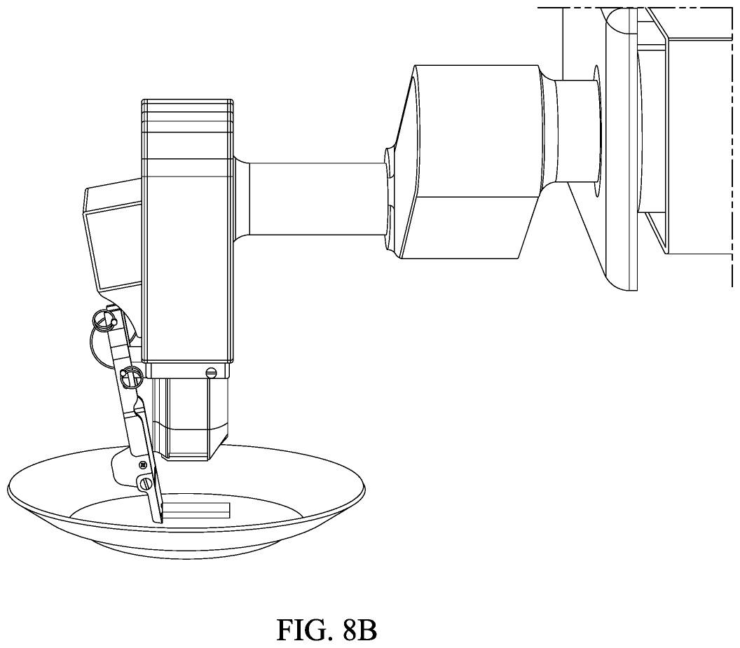

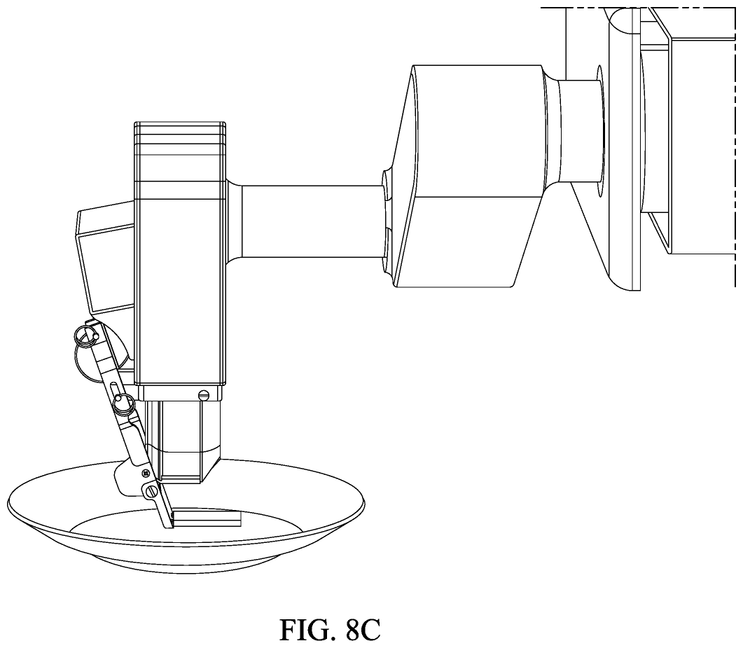

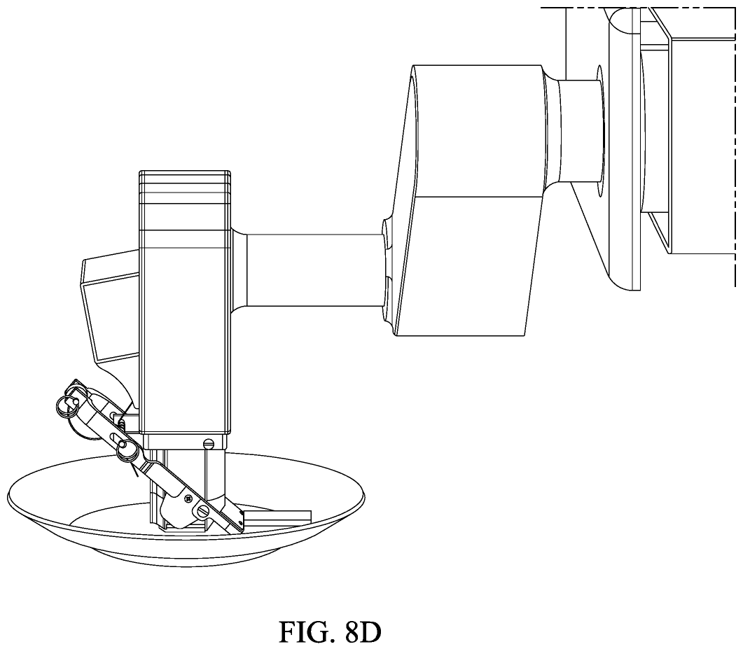

The scraper bar 2193 and frame members 2190 are angled relative to the pivot 2191, such as an angle of between 10 and 25 degrees relative to the direction of actuation of the magnet 2090 by the linear actuator 2091. Due to this angle, as the scraper bar 2193 is brought into contact with a dish (see FIGS. 8A and 8B) and pressed against the surface of the dish, the force of the contact causes the scraper bar 2193 to exert a moment about the pivot 2191 thereby rotating the scraper bar (see FIGS. 8C and 8D) and pushing the scraper bar across an area that will be contacted by the end cap 2093, thereby clearing the surface of debris. In particular, the downward motion of the end effector 2081 urges the scraper bar 2193 against a surface of the dish, which causes the scraper bar to deflect and perform the sweeping/scraping motion.

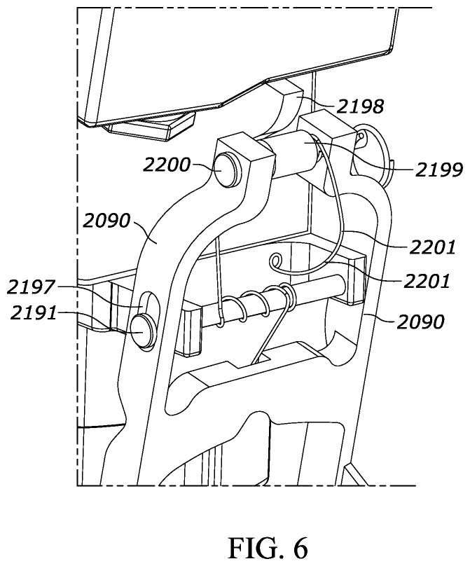

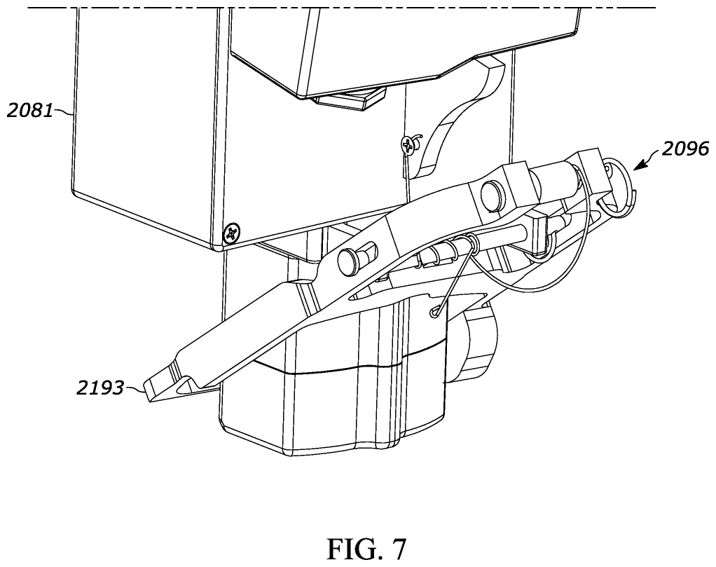

In some embodiments, a hard stop of the scraper bar is implemented such that when the scraper bar 2193 contacts the dishware, the force vector at the contact point creates a moment on the scraper bar that rotates the scraper bar in the desired direction (across to an opposite side of the sheath 2092 from the pivot 2191) to perform the scraping action. In situations where the force vector does not create enough of a moment or the moment is in the wrong direction, the scraper bar 2193 will jam and not scrape the dishware, potentially breaking the scraper bar 2093 or frame members 2190, which can happen if the dishware surface is severely unlevel when the scraper bar makes contact. FIG. 6 is a more detailed view of the mechanism that supports movement of the scraper. Referring to FIG. 6, to prevent movement of the scraper bar in the wrong direction, the nominally fixed pivot lever mechanism may be augmented with a slotted pivot in which the frame members 2190 define slots 2197 through which the pivot 2191 passes and along which the pivot can slide. A cam surface 2198 may be secured to the end effector and engage a roller 2199 secured to the frame, such as to a second pivot pin 2200 extending between the frame members 2190. As is apparent, the cam surface 2198 slopes outwardly from the end effector with distance from the end cap 2093 such that when the frame is pushed upwardly, the pivot 2191 slides within the slots 2197, pushing the roller 2199 against the cam surface 2198 and therefore outwardly from the end effector 2081, thereby increasing the angle of the frame portions 2190 relative to the end effector 2081. A spring 2201 may provide a restoring force that resists this upward movement such that when the end effector 2081 is not pressing the scraper bar 2193 against dishware, the frame portions will slide downwardly along the pivot 2191 such that the pivot 2191 will be at the upper end of the slots 2197 (opposite to what is shown in FIG. 6). In the illustrated embodiment, the spring 2201 is a resilient wire that couples pivot 2191 to pivot 2200 passing through the roller 2199 and urging the pivots 2191, 2200 toward one another. The pivot may extend between openings defined by the frame member 2190. The slotted pivot 2197 and rolling cam mechanism 2198, 2199 as shown in FIG. 6 reduces jamming of the scraper bar 2193 within a reasonable range of dishware level variation, and will consistently bias the scraper bar to rotate in the correct direction and scrape the dishware surface. If the contact point force vector at the scraper bar 2193 points at the pivot 2191 (e.g., less than 3 degrees off) and provides no moment about the pivot 2191, the scraper bar 2193 will shift up along the slot 2197 and be rotated by the cam surface 2198 engaging the roller 2199 such that the force vector is no longer pointing at the pivot 2191. This provides enough displacement to apply a moment on the scraper bar 2193 about the pivot 2191 (see FIGS. 7-8D).

FIG. 7 depicts the end effector 2081 and the scraper 2096 with the scraper bar 2193 in a position that exists after the scraper bar has been forced to sweep entirely across the surface of an article of dishware. FIG. 7 represents the position of the scraper bar while an article of dishware is magnetically attached to the end effector even though the article of dishware is not shown in FIG. 7 for clarity. Once the article of dishware is released by the magnetic end effector, the spring-loaded scraper bar will be forced to rotate back to its at rest, or natural position, as shown, for example, in FIG. 5.

FIGS. 8A-8D illustrate how the scraper bar 2193 of the scraper 2096 clears an area on a surface of a dish by sweeping the scraper bar over the top surface of the dish. FIG. 8A illustrates the position of the end effector 2081 as the end effector is moved near to a top surface of a top dish 2010 in a stack of dishware. FIG. 8A also shows that a piece of debris 2012 is present on the top surface of the dish 2010. In an embodiment, the end effector is moved towards the dish is in response to rotation of the arm 2080 around the shaft 2087. FIG. 8B illustrates the point at which the scraper bar 2193 first contacts the surface of the dish 2010 due to the motion of the end effector relative to the dish. FIG. 8C illustrates the linear movement of the scraper bar along the surface of the dish as the scraper mechanism rotates about the pivot 2191 in response to the downward movement of the end effector relative to the plate. Additionally, FIG. 8C illustrates that the scraper bar begins to clear the debris 2012 from the surface of the dish at the location at which the distal end of the magnetic end effector will contact the dish. FIG. 8D illustrates the position of the scraper once the end effector has contacted the dish and magnetically engaged the dish so that the dish can be manipulated by movement of the arm. As illustrated in FIG. 8D, the debris 2012 has been cleared from the area at which the end effector magnetically engages with the dish. At this point in the process, the scraper is positioned similar to that described with reference to FIG. 7. With the dish magnetically engaged by the end effector, the dish can be moved to another location in the dish washing system for further processing, e.g., for washing. Once the dish has been moved to the desired location, the dish can be released by the end effector by retracting the magnet 2090. After the dish is released from the end effector, the spring loaded scraper will sweep in the opposite direction back to the at rest position of the scraper as shown in FIG. 8A. In an embodiment, as the scraper bar sweeps back to its at rest position, the flap 2194 (see FIG. 5) brushes across the end cap 2093 of the end effector, which can help to remove debris from the end cap which may have stuck to the end cap during the magnetic grasping of the dish.

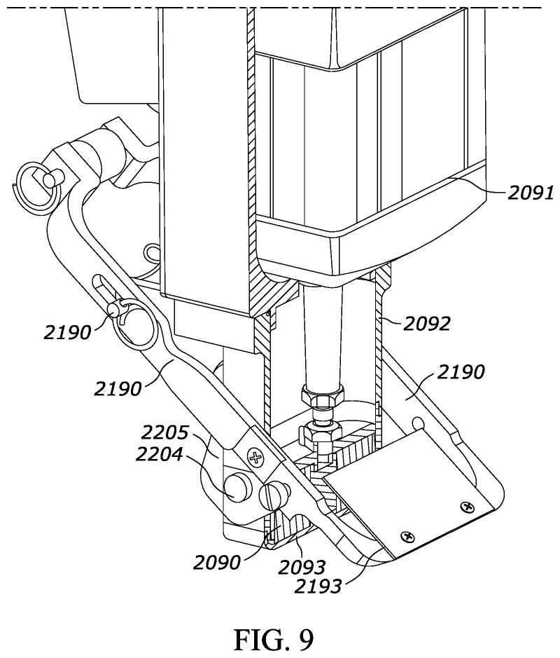

As debris is scraped off the dishware, loosened debris collects on the scraper bar and extension. During its motion, the scraper bar can become jammed against the housing of the end effector 2081 due to excessive debris. This issue may be mitigated by implementing a stiffer torsion spring 2192 for the scraper bar 2193. However, the stiffer spring 2192 would cause the scraper bar 2193 to push against the dishware with greater force and apply a pry-off force on the dishware countering the grasping force that the end effector 2081 is applying on the dishware. Referring to FIGS. 9-11, to mitigate this issue, a magnetic latching mechanism may be used. For example, a small permanent magnet 2204 is attached to one or both of the frame members 2190 and interacts with the internal translating magnet 2090 in the end effector 2081. In the illustrated embodiment, each magnet 2204 secures to a flap or extension 2205 fastened to one of the frame members 2190.

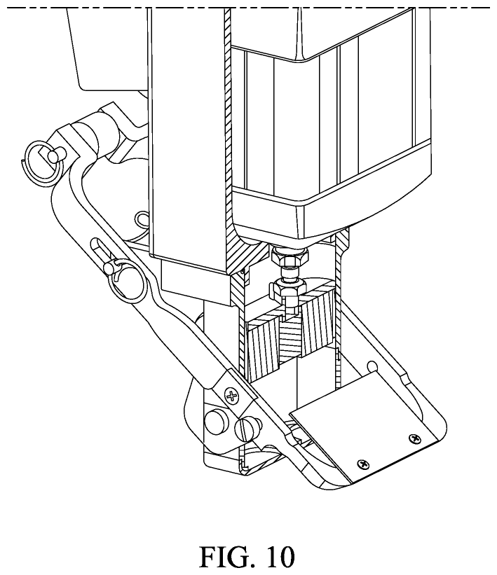

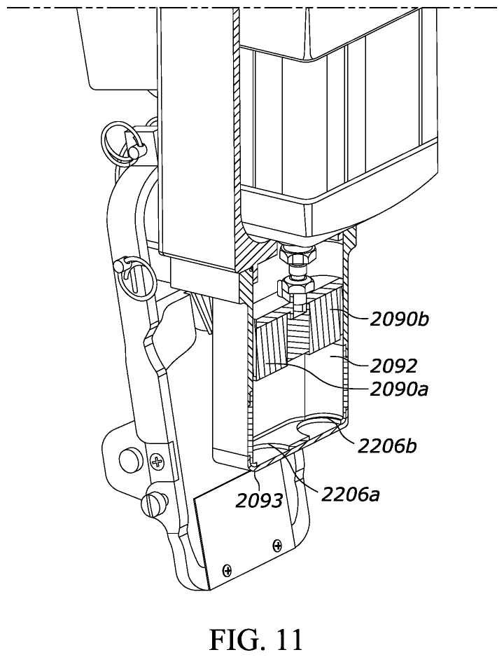

When the end effector 2081 is grasping the dishware, the magnet 2090 is extended, and the scraper bar 2193 is fully deflected as shown in FIG. 9. In this configuration, the scraper bar magnet 2204 is attracted to the magnet 2090 inside the end effector 2081, which urges the scraper bar upwardly, e.g., to maintain its pivoted position and resisting the restoring force of the spring 2192. This relieves the spring force that the spring 2192 would otherwise apply on the grasped dishware. When the end effector 2081 retracts the magnet 2090 to release the dishware as shown in FIG. 10, it pulls the magnet 2090 away from the scraper bar magnet 2204, thereby reducing the magnetic attraction and releasing the scraper bar. The torsion spring 2192 then pivots the scraper bar 2193 back across the end effector to its undeflected position as shown in FIG. 11. This enables a more cleanable, sealed mechanical design, as the linear actuator 2091 can drive the scraper bar latching behavior without cutting through the otherwise continuous, closed end effector housing.

FIG. 11 also illustrates another feature that may be used in some embodiments. Note that sheath 2092 may be made of a rigid plastic or metal and further includes portions extending over the end of the sheath 2092 covered by the end cap 2093 made of a flexible material. In the illustrated embodiment, the end portion of the sheath 2092 defines openings 2206a, 2206b sized to receive portions of magnets 2090a, 2090b protruding outwardly from the spacer 2180, thereby enabling the magnets 2090a, 2090b to be closer to a dish being grasped thereby and to reduce interference with the magnetic field of magnets 2090a, 2090b by the sheath 2092 when it is made of metal. These openings 2206a, 2206b may be covered by the end cap 2093.

To improve cleanability of the dish scraper mechanism, the moving elements of the mechanism may be fastened with toolless, quick-release attachment elements such as clevis pins with cotter rings. Also, the mechanism may use wire-formed springs to promote cleanability of the exposed spring elements.

In an embodiment, dishes may be brought into a robotic dishwashing system in stacks on dish carts. Cleaning operations, whether scrubbing or otherwise, may be performed individually on dishes rather than on stacks of dishes. Dishes may be parsed from the stack (aka destacked) and transferred from the stack into another part of the dish cleaning system, such as a conveyance system for scrubbing as described in the following U.S. patent applications, which are hereby incorporated herein by reference in their entirety, “DISHWASHING CONVEYANCE SYSTEM AND METHOD,” Ser. No. 16/201,809, filed on Nov. 27, 2018, and “DISHWASHING CONVEYANCE SYSTEM AND METHOD,” Ser. No. 16/201,822, filed on Nov. 27, 2018.

Although embodiments of the end effector, grasping element, and scraper are described herein, other embodiments of the end effector, grasping element, a scraper are possible. For example, the spring-loaded scraper mechanism can be implemented in different ways while still clearing the surface of a dish before the grasping element grasps the object at the surface. In additional, although the end effector and grasping element are described with reference to dishware, the end effector and grasping element can be used to grasp other objects, including to destack other stacked objects.

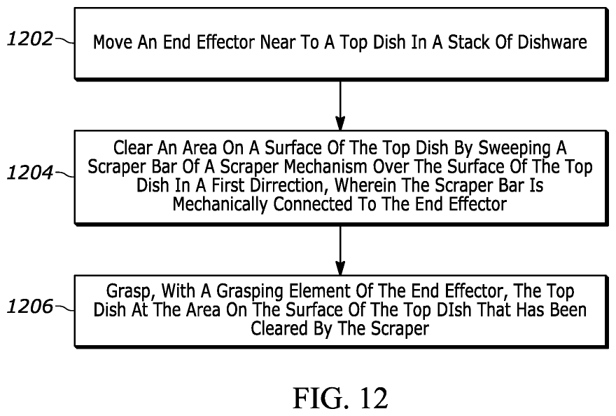

FIG. 12 is a process flow diagram of a method for mechanically destacking dishware. At block 1202, an end effector moves near to a top dish in a stack of dishware. At block 1204, an area on a surface of the top dish is cleared by sweeping a scraper bar of a scraper mechanism over the surface of the top dish in a first direction, wherein the scraper bar is mechanically connected to the end effector. At block 1206, the top dish is grasped, with a grasping element of the end effector, at the area on the surface of the top dish that has been cleared by the scraper. In an embodiment, the process can be implemented using the apparatus as described above with reference to FIGS. 1-11.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus comprising:
a robotic arm; and
an end effector connected to the robotic arm, the end effector including;
a grasping element for grasping an object; and
means for clearing a surface of the object before the grasping element grasps the object at the surface.

2. The apparatus of claim 1, wherein the means for clearing includes a rigid scraper bar.

3. The apparatus of claim 1, wherein the means for clearing includes a spring-loaded scraper mechanism.

4. The apparatus of claim 3, wherein the spring-loaded scraper mechanism includes a rigid scraper bar.

5. The apparatus of claim 4, wherein the spring-loaded scraper mechanism includes a torsion spring attached to a pivot to provide increased tension as the scraper bar rotates about the pivot to clear the surface of the object.

6. The apparatus of claim 3, wherein the spring-loaded scraper mechanism is configured to sweep across the surface of the object in response to a force applied to the spring-loaded scraper mechanism by contact between the rigid scraper bar and the surface of the object.

7. The apparatus of claim 3, wherein the spring-loaded scraper mechanism includes a flap connected to clear a surface of the grasping element.

8. The apparatus of claim 7, wherein the flap is connected to the spring-loaded scraper mechanism to clear the surface of the grasping element after the grasping element has released the object from its grasp.

9. The apparatus of claim 1, wherein the means for clearing includes a locking mechanism that locks the means for clearing in a fixed position while the grasping element is grasping the object.

10. The apparatus of claim 1, wherein the grasping element includes a linearly actuated retractable magnet attached at a distal end of the end effector.

11. The apparatus of claim 10, wherein the means for clearing includes a locking mechanism that locks the means for clearing in a fixed position while the linearly actuated retractable magnet is in an extended position.

12. The apparatus of claim 11, wherein the locking mechanism comprises a locking element integrated into the means for clearing such that the locking element is held in position by magnetic attraction between the linearly actuated retractable magnet and the locking element when the linearly actuated retractable magnet is in the extended position.

13. The apparatus of claim 10, wherein a linear direction of travel of the linearly actuated retractable magnet and the area that is cleared by the means for clearing are linearly aligned with each other.

14. The apparatus of claim 1, wherein the grasping element includes a channel opening through which a vacuum can be provided.

15. A method for mechanically destacking dishware, the method comprising:
moving an end effector near to a top dish in a stack of dishware;
clearing an area on a surface of the top dish by sweeping a scraper bar of a scraper mechanism over the surface of the top dish in a first direction, wherein the scraper bar is mechanically connected to the end effector; and
grasping, with a grasping element of the end effector, the top dish at the area on the surface of the top dish that has been cleared by the scraper.

16. The method of claim 15, further comprising releasing the dish that is grasped by the grasping element and, after the dish is released, clearing a surface of the grasping element by sweeping the scraper bar of the scraper mechanism in a second direction that is opposite the first direction.

17. The method of claim 16, wherein the scraper bar is swept in the second direction by a torsion spring.

18. The method of claim 15, wherein the scraper bar is swept over the surface of the top dish by pressing the scraper mechanism against the surface of the top dish.

19. The method of claim 18, further comprising releasing the dish that is grasped by the grasping element and, after the dish is released, clearing a surface of the grasping element by sweeping the scraper mechanism in a second direction that is opposite the first direction.

20. The method of claim 19, further comprising locking the scraper mechanism in place while the dish is grasped by the grasping element.

21. An apparatus for destacking stacked dishware, the apparatus comprising:
a robotic arm; and
an end effector connected to the robotic arm, the end effector including;
a magnetic grasping element for grasping a top dish from a stack of dishware; and
a spring-loaded scraper mechanism configured to clear a surface of the top dish before the magnetic grasping element grasps the top dish at the surface.

22. The apparatus of claim 21, wherein the spring-loaded scraper mechanism includes a rigid scraper element.

23. The apparatus of claim 22, wherein the spring-loaded scraper mechanism includes a flap connected to a side frame member of the spring-loaded scraper mechanism to clear the surface of the grasping element after the grasping element has released the dish from its grasp.

24. The apparatus of claim 22, wherein the spring-loaded scraper mechanism includes a locking mechanism configured to lock the scraper bar in a fixed position after the scraper bar has cleared the surface of dish.

25. The apparatus of claim 24, wherein the magnetic grasping element includes a linearly actuated retractable magnet and wherein the locking mechanism comprises a locking element integrated into a side frame member of the spring-loaded scraper mechanism such that the locking element is held in position by magnetic attraction between the linearly actuated retractable magnet and the locking element when the linearly actuated retractable magnet is in an extended position.
